(19) United States
(12) Patent Application Publication
(10) Pub. No.: US 2026/0147146 A1
(43) Pub. Date: May 28, 2026

(54) SOLAR CONTROL MATERIAL FOR AIRCRAFT TRANSPARENCIES

(71) Applicant: THE NORDAM GROUP LLC, Tulsa, OK (US)

(72) Inventors: Richard Hopkins, Tulsa, OK (US); Ronald Meline, Tulsa, OK (US); Parham Asgari, Tulsa, OK (US)

(73) Assignee: THE NORDAM GROUP LLC, Tulsa, OK (US)

(21) Appl. No.: 19/354,967

(22) Filed: Oct. 10, 2025

Related U.S. Application Data
(60) Provisional application No. 63/711,311, filed on Oct. 24, 2024.

(51) Int. Cl. G02B 5/20; G02B 1/04

(52) U.S. Cl. CPC G02B 5/208; G02B 1/04

(57) ABSTRACT

Certain novel compositions, processes for producing such compositions, aircraft transparencies, and processes for manufacturing aircraft transparencies are described. A process (200) for solar control material and manufacturing an aircraft transparency involves obtaining (212) a tungsten oxide product and implementing a solvent exchange process to re-disperse (208) a tungsten oxide component in MMA. The MMA product is then converted (214) to PMMA by casting and used to form a transparency or stretched and then used to form a transparency (218 or 224).

### RELATED APPLICATION

This application claims the benefit of U.S. Provisional Patent Application No. 63/711,311, entitled “SOLAR CONTROL MATERIAL FOR AIRCRAFT TRANSPARENCIES” filed Oct. 24, 2024.

### FIELD OF THE INVENTION

The present invention relates generally to transparencies for aircraft, including fixed wing and rotary wing aircraft, for example, manned or unmanned electronic vertical takeoff and landing (eVTOL) aircraft. In particular, the invention relates to transparencies having solar control properties.

### BACKGROUND OF THE INVENTION

Thermoplastic materials, such as acrylic, are used for aircraft transparencies, e.g., canopies, cockpit windows, cabin windows, and the like, and have several beneficial properties for such applications. In particular, acrylic materials are lightweight, strong, and have excellent transparency. These materials are also impact resistant, weather resistant, and do not shatter. Thermoplastic materials including acrylic materials have therefore gained widespread acceptance for aircraft transparency applications.

However, there are continuing efforts towards improving the solar control properties of aircraft transparencies. Ideally, aircraft transparencies should have high transmissivity for visible spectrum light (for optical transparency) but should have lower transmissivity for near infrared (NIR) and ultraviolet (UV) radiation. NIR radiation can cause the aircraft interior to heat up, which may be uncomfortable for manned aircraft or undesirable for equipment. UV radiation can be harmful to aircraft equipment or materials.

Various approaches to solar control have been proposed or implemented. In some cases, films or inter-layers of laminated construction have been used to filter desired spectral components. However, films can be difficult or expensive to apply to stretched acrylics or other transparencies having complex shapes including in certain eVTOL aircraft transparencies. In other cases, additives have been provided in acrylic formulations for solar control. However, it is difficult to achieve solar control acrylics that have suitable transmissivities in the UV, visible, and NIR spectrums and that also avoid undesirable tints.

### SUMMARY OF THE INVENTION

The present invention is directed to aircraft transparencies (e.g., stand-alone canopies, windows, or the like or components/layers thereof), as well as associated compositions and construction processes, involving a thermoplastic material with one or more additives for solar control. The invention provides materials with high transmissivity in the visible spectrum, without undesirable tints, and reduced UV and NIR transmissivities, and that otherwise have suitable mechanical properties for use as an aircraft transparency material. The invention further relates to the use of tungsten components, such as tungsten oxide (WO) and cerium-doped tungsten oxide (CWO), as acrylic additives. As used herein, WO and CWO encompass various compounds and molecular structures including tungsten and oxygen, and cesium, tungsten, and oxygen, respectively. Moreover, a novel solvent replacement process is provided for enabling available tungsten oxide-containing products to be used to produce an acrylic material with a tungsten oxide additive. In this manner, a thermoplastic material is provided with intrinsic solar control properties for aircraft transparencies without requiring films or interlayer materials for solar control.

In accordance with one aspect of the present invention, a transparency is provided for an aircraft such as a fixed wing aircraft or a rotary wing aircraft, e.g., an eVTOL. The transparency includes a solar control product dimensioned to function as a desired aircraft transparency where the solar control product comprises a thermoplastic material, such as an acrylic material, and a tungsten oxide component. For example, the solar control product may have: a first transmissivity for visible spectrum radiation of at least 60% and, more preferably, at least 70%; a second transmissivity for NIR radiation of no more than 40% and, more preferably, no more than 30%; and a third transmissivity for UV radiation of no more than 10% and, more preferably, no more than 5%. The tungsten oxide containing transparency thereby provides suitable transparency for use as an aircraft transparency while reducing transmitted NIR and UV radiation.

In one implementation, the WO component is provided as an acrylic additive dispersed in the acrylic material. As described below, the acrylic additive may be obtained via a solvent exchange process. The WO component may include CWO and preferably comprises no more than 0.1%, for example, between 0.02-0.05% by weight of the solar control product. The concentration of the WO or CWO product may vary, for example, depending on the thickness of the transparency and any other solar control layers in the case of a multi-layer laminated product. For example, in some cases, the transparency product may include a CWO-acrylic layer bonded to or used in conjunction with another layer formed of acrylic or other material, or a solar control film may be used. In general, the transmissivity of the solar control product or layer, for various spectral components, is a function of the path length of light through the transparency or layer and, if multiple solar control layers are utilized, their combined solar control properties will need to be considered. Alternatively, a WO component such as CWO may be used with other thermoplastic materials such as polyurethane or polysiloxane, e.g., to provide a solar control film or layer that can be applied to a substrate (e.g., of acrylic, glass, or other material) to provide an aircraft transparency.

The solar control product may further include a dye to provide a desired tint to the aircraft transparency. For example, the desired tint may have a grey hue, e.g., the aircraft transparency may be achromatic so that it is perceived as not having any color, other than black or white shades, in the visible spectrum. That is, the red, green, and blue spectral components of the aircraft transparency may be substantially equal. CWO-acrylic products generally have a bluish hue that can be readily dyed to a grey huc.

In accordance with another aspect of the present invention, a method for manufacturing an aircraft transparency is provided. The method involves providing a solar control product including an acrylic material and a tungsten oxide component and processing the solar control product so that it is formed into the desired dimensions for the aircraft transparency. In one implementation, the noted processing involves stretching the solar control sheet and then forming the stretched solar control sheet to the final form of the aircraft transparency. Stretching of the solar control sheet may be implemented by pressing or drawing the solar control sheet where the stretched solar control sheet has an area greater than the solar control sheet before it was stretched.

In accordance with a further aspect of the present invention, a method for producing a solar control product is provided. The method involves obtaining a tungsten oxide-acrylic material via a solvent exchange process and using the material to form the solar control product. The solvent exchange process involves providing a source product, where the source product includes WO and a first solvent, and exchanging a second solvent for the first solvent. For example, the source product may include CWO. In one implementation, the first solvent comprises water and the second solvent comprises methyl methacrylate (MMA). The process may involve removing water from the source product to obtain a concentrated mixture (e.g., by rotary evaporation), introducing the concentrated mixture into the MMA, and dispersing the concentrated mixture in the MMA to provide an MMA formulation. In this regard, the concentrated mixture may comprise tungsten oxide, a dispersing agent, and residual water. The process may further involve removing residual water from the MMA formulation, for example, by adding magnesium sulfate to the MMA formulation. Solids may then be removed from the MMA formulation, e.g., via a vacuum filtration process and/or by passing the MMA formulation through a celite packed filtration substrate. Additional water may be removed from or kept from the MMA formulation using a molecular sieve.

### BRIEF DESCRIPTION OF THE DRAWINGS

For a more complete understanding of the present invention, and further advantages thereof, reference is now made to the following Detailed Description, taken in conjunction with the drawings, in which:

FIGS. 1A-1C illustrate various aircraft showing transparencies that may be provided in accordance with the present invention;

FIG. 2 is a flowchart illustrating a process for providing a solar control material and manufacturing an aircraft transparency in accordance with the present invention.

### DETAILED DESCRIPTION

The present invention relates to certain novel compositions, processes for producing such compositions, aircraft transparencies, and processes for manufacturing aircraft transparencies, among other things. In the following description, the invention is set forth in the context of producing a cerium-doped tungsten oxide (CWO) acrylic material and manufacturing aircraft transparencies using that material. However, various aspects of the invention are not limited to this context. Accordingly, the following description should be understood as illustrative and not by way of limitation.

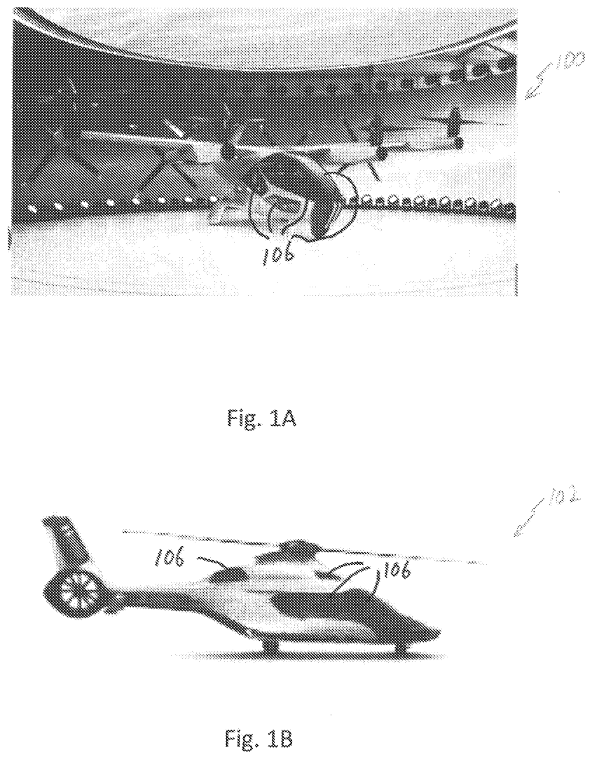

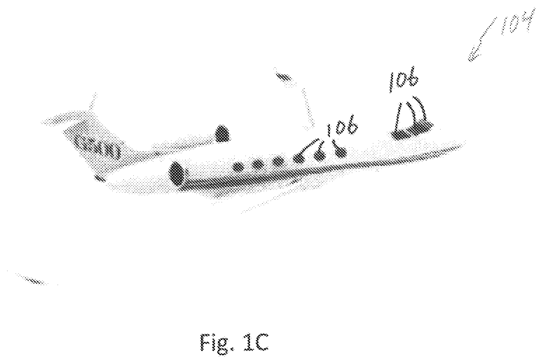

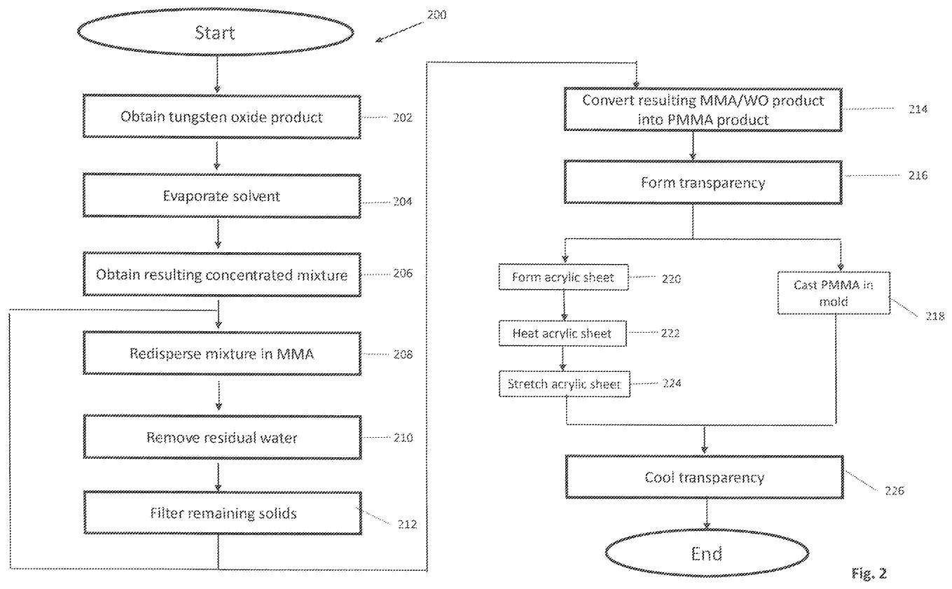

Transparencies are used in a variety of aircraft. FIGS. 1A-1C show three examples of types of aircraft in which the transparencies of the present invention may be employed, and it will be appreciated that many other examples are possible. Specifically, FIG. 1A shows an eVTOL 100, FIG. 1B shows a rotary wing aircraft 102, and FIG. 1C shows a fixed wing aircraft 104. Each of the aircraft 100, 102, and 104, includes transparencies 106. Such transparencies 106 may include canopies, cockpit windows, cabin windows, hatch or door windows, nosecone transparencies, lower cockpit windows, upper cockpit windows, upper cabin windows, etc.

In many cases, such transparencies 106 have been formed from acrylic such as cast acrylic or stretched acrylic. Such acrylic materials provide excellent transparency and mechanical properties for aircraft transparencies. The present invention involves the use of CWO as a solar control material. A process is described below for using CWO as an acrylic additive. The resulting CWO acrylic product can then be used to manufacture a variety of solar control products such as aircraft transparencies including any of the transparencies 106 shown in FIGS. 1A-1C. the resulting product has suitable transparency and mechanical properties for aircraft transparencies and has lowered transmissivity for an IR and UV radiation in relation to conventional acrylic materials without additives. Moreover, unlike certain acrylics with additives, the transparencies of the present invention can be provided or readily dyed to have various gray hues as may be desired by manufacturers. It will be appreciated that manufacturers may prefer uncolored tints to avoid distorting the spectral content of objects or landscapes viewed through the transparencies.

FIG. 2 illustrates a process 200 for 1) providing a CWO acrylic material, and 2) manufacturing an aircraft transparency from the CWO acrylic material in accordance with the present invention. The process 200 is initiated by obtaining (202) a WO product such as a CWO product for use in the process 200. It will be appreciated that, due to certain government regulations, it may be impossible or impractical to obtain raw WO or CWO for use in the process 200. Rather, it may be necessary or useful to obtain a commercial product that includes WO or CWO dissolved in a solvent. In the illustrated implementation, the YMW-20D product manufactured by Sumitomo Chemical Co. Ltd., is used as the source WO product. This product includes CWO dissolved in water with dispersing agents and other components.

The solvent can then be evaporated (204) from the source WO product. In the illustrated implementation, this can be accomplished, for example, via a rotary evaporation process or by a thin film or wiped film evaporation process. In the case of a rotary evaporation process, a carefully measured volume of the source WO product is transferred into a rotary evaporator or other container. The container is then attached to the rotary evaporator device and the bath temperature is set. The initial temperature will depend on the batch size, vacuum power, coolant temperature, and potentially other factors. In one example, for a 500 g batch size, a 10 Torr vacuum, and a 10° C. coolant, the initial temperature of the bath was 30° C. Rotation of the rotary evaporator can then be initiated while gradually applying a vacuum to maintain a steady condensation and avoid bumping. The temperature of the bath may be gradually increased under full vacuum and the bath should be monitored closely until a steady condensation begins. Evaporation can then continue until most of the water is removed. A thick concentrated mixture will remain that includes CWO, a dispersing agent, glycol ethers, and residual water.

The resulting concentrated mixture may then be obtained (206) and re-dispersed (208) into an MMA solvent. In this regard, the concentrated mixture may be provided in the same container used during evaporation or may be transferred to a new container. In either case, the mixture and container are preferably cooled to room temperature before adding MMA to reduce safety risks due to volatility and flammability. The required amount of MMA is then measured and added to the concentrated mixture. The amount added will depend on the desired final concentration taking into account any additional amounts required for rinsing or other steps to achieve the desired final concentration. It will be appreciated that the desired final concentration can vary depending on the application. For typical aircraft transparency applications, it is anticipated that the final concentration should be selected to provide: 1) a first transmissivity in the visible spectrum of at least 60% and, more preferably at least 70%; 2) a second transmissivity in the NIR spectrum of no more than 40% and, more preferably, no more than 30%; and 3) a third transmissivity in the UV spectrum of no more than 10% and, more preferably, no more than about 5%. In the illustrated example, the final product preferably includes no more than 0.1% and, more preferably, between a 0.02-0.05% by weight of the CWO additive. It will be appreciated that the optical properties may be affected by dyes or other components added to the product or additional films or other layers in the case of a laminated, multi-layer transparency. The concentrated mixture can be dispersed in the MMA by gentle mixing or mechanical agitation. Glass or ceramic beads can be added to aid in the re-dispersing of gummy residues. This process is continued until complete CWO dispersion is observed or measured. The result is a CWO-acrylic formulation.

Next, residual water may be removed (210) from the CWO-acrylic formulation. Any appropriate dehydrating process may be employed. In the illustrated process 200, a magnesium sulfate process is employed. Accordingly, an appropriate amount of magnesium sulfate is calculated based on the batch volume and estimated residual moisture. For example, 20 g of magnesium sulfate may be used for each 100 g of the source WO product (e.g., YMW-D20). In the illustrated implementation, when the appropriate amount of magnesium sulfate is added, it precipitates in the form of solid clumps or crystals that can be skimmed from the mixture. The magnesium sulfate should be added gradually while continuously mixing the mixture. This process is continued for a sufficient time to remove water, for example, about 30 minutes.

Any remaining solids can then be filtered (212) from the mixture. For example, a vacuum filtration process may be employed. In this regard, celite may first be packed on filter paper, insuring an even layer without gaps for more effective filtration. The mixture can then be passed through the filter and the filtrate can be collected in a clean container. The filtered solids may then be combined with a measured amount of MMA to recover any remaining product. A vacuum trap may be incorporated between the filter container and vacuum pump to prevent filtrate loss. Additionally, an ice bath may be used around the vacuum trap to efficiently condense MMA vapors, preventing them from reaching and potentially damaging the pump. If Glass or ceramic beads were used for agitation, they may be recovered after filtration. It should be appreciated that alternative filtration methods such as pressure filtration or tangential flow filtration may be utilized and may improve recovery and efficiency. Such methods can improve process speed and scalability.

Optionally, molecular sieves may be used for further water removal. If extremely low residual moisture is desired, pre-activated molecular sieves may be added to the final product for long-term storage. If needed, the molecular sieves may be activated by rinsing the sieves with inert solvents such as methanol or ethanol and drying at 100-120° C. to remove solvent residues. The sieve can then be activated by heating at 200-300° C. for 4-6 hours, depending on the sieve type, to dehydrate fully. The sieves can then be cooled in a desiccator or sealed container to prevent moisture reabsorption and stored in airtight containers until use. The CWO/MMA product is preferably stored at a cold temperature, e.g., −20° C. Before use, the mixture should be allowed to reach room temperature and shaken well. If molecular sieves were used, the sieves can be removed by filtration prior to use.

The process for producing the mixture, as well as examples of equipment and alternatives, is summarized in the following table:

| | Rotary Evaporator | |
|---|---|---|
| 1 | Base unit (Heidolph or Buchi) | Heidolph Instruments: Rotary Evaporators (heidolph- |
| | Model choice depends on budget and | instruments.com) Instruments \| Buchi.com |
| | desired scale. | |
| 2 | Vacuum pump | Consider purchasing as a set with the rotary evaporator |
| 3 | Recirculating chiller | for compatibility and potential cost savings. |
| 4 | Oval shaped flask | CG-1512 - FLASKS, EVAPORATING, HEAVY WALL, SINGLE NECK, |
| | | RECOVERY-Chemglass Life Sciences |
| | Vacuum filtration apparatus | |
| 5 | Chemical resistant diaphragm vacuum | CG-4812-30 - VACUUM PUMPS, TWO HEAD, PTFE DIAPHRAGM, |
| | pump | CHEMGLASS-Chemglass Life Sciences |
| 6 | Filter Flask, heavy walls | CG-1550 - FLASKS, FILTERING, HEAVY WALL- Chemglass Life |
| | | Sciences |
| 7 | Fritted Büchner funnel | CG-1406-E - FILTER FUNNELS, BUCHNER, INNER JOINTS, |
| | | IMPROVED- Chemglass Life Sciences |
| 8 | Vacuum Trap | CG-4531 - VACUUM TRAPS- Chemglass Life Sciences |
| 9 | Dewar | CG-1593 - FLASKS, DEWAR, CYLINDRICAL, WIDE MOUTH- |
| | | Chemglass Life Sciences |
| 10 | Filter paper | |
| | Matchin Büchner funnel diameter | |
| | Materials | |
| 11 | Celite filter aid | Celite \| Sigma-Aldrich (sigmaaldrich.com) |
| 12 | Anhydrous magnesium sulphate | Magnesium sulfate anhydrous, free-flowing, Redi-Dri CAS No. |
| | | 7487-88-9 Sigma-Aldrich (sigmaaldrich.com) |

The CWO/MMA product can then be used to manufacture a solar control product such as an aircraft transparency. The product is converted (214) into a PMMA product using known polymerization techniques to form a thermoplastic acrylic polymer. This PMMA product is then used to form (216) a transparency or is then stretched and is then used to form a transparency. In either case, the process will depend on the desired final thickness, shape, and performance requirements of the transparency. For certain aircraft transparency applications, the thickness may be between 0.08-0.4 inches and, more preferably, between about 0.1-0.25 inches. It will be appreciated that, in certain manufacturing contexts, a CWO-acrylic material for use in aircraft transparencies will be manufactured by a first entity or unit (first party), and the CWO-acrylic material will then be formed into the transparencies by a second entity or unit (second party). In such cases, the first party may provide an intermediate planar CWO-acrylic product (cast or stretched) of the appropriate thickness, taking into account the application of the second party and any additional processing by the second party (e.g., stretching, molding or otherwise forming) that change the final shape or thickness of the transparency.

In the illustrated casting example, the PMMA material is cast (218) in a mold having appropriate dimensions for the desired transparency, e.g., the appropriate thickness in the case of an intermediate planar sheet product or the actual dimensions of the transparency in the case of final product manufacturing. In the case of stretching, the PMMA material may first be used to form (220) an acrylic sheet. In some cases, this is the product provided by a first party to a second party of a manufacturing process. The acrylic sheet may then be heated (222) to its softening point and stretched (224) to form the transparency. For example, the acrylic sheet may be pressed or drawn into a form for the desired transparency, where the transparency has a greater area but reduced thickness in relation to the acrylic sheet. Such stretching may be performed with respect to at least two axes. Finally, whether the transparency is formed by casting or stretching, the transparency may be cooled to below the softening temperature of the PMMA and removed from the mold or form.

The foregoing description of the present invention has been presented for purposes of illustration and description. Furthermore, the description is not intended to limit the invention to the form disclosed herein. Consequently, variations and modifications commensurate with the above teachings, and skill and knowledge of the relevant art, are within the scope of the present invention. The embodiments described hereinabove are further intended to explain best modes known of practicing the invention and to enable others skilled in the art to utilize the invention in such, or other embodiments and with various modifications required by the particular application(s) or use(s) of the present invention. It is intended that the appended claims be construed to include alternative embodiments to the extent permitted by the prior art.

1. A solar control transparency for an aircraft, comprising:
a solar control product, dimension to function is a desired aircraft transparency, said solar control product having a first transmissivity for visible spectrum radiation of at least 60%, a second transmissivity for near infrared radiation of no more than 40%, and a third transmissivity for ultraviolet radiation of no more than 10%;
said solar control product comprising a thermoplastic material and a tungsten oxide component.

2. The transparency of claim 1, wherein said thermal plastic material comprises an acrylic material.

3. The transparency of claim 2, wherein said tungsten oxide component is an acrylic additive dispersed in said acrylic material.

4. The transparency of claim 2, wherein said tungsten oxide component comprises cerium doped tungsten oxide.

5. The transparency of claim 1, wherein said tungsten oxide component comprises no more than 0.1% by weight of said solar control product.

6. The transparency of claim 1, wherein said tungsten oxide component comprises no more than 0.02-0.05% by weight of said solar control product.

7. The transparency of claim 1, wherein said tungsten oxide component is obtained via a solvent exchange process involving providing a source tungsten oxide containing product, said source tungsten oxide containing product including tungsten oxide and a first solvent, and said solvent exchange process involves exchanging a methyl methacrylate (MMA) solvent for said first solvent.

8. The transparency of claim 1, wherein said solar control product comprises a solar control sheet formed from said thermal plastic material and said tungsten oxide component.

9. The transparency of claim 8, wherein said sheet has a thickness of between 0.08-0.4 inches.

10. The transparency of claim 8, wherein said aircraft transparency comprises one of a canopy, a cockpit window, and a cabin window.

11. The transparency of claim 1, wherein said solar control product further comprises a dye to provide a desired tint to said solar control product.

12. The transparency of claim 11, wherein said dye is selected so that said tint is a grey hue.

13. The transparency of claim 2, wherein said acrylic material comprises poly (methyl methacrylate) PMMA.

14. The transparency of claim 1, wherein said first transmissivity is at least 70%, said second transmissivity is no more than 30% and said third transmissivity is no more than 5%.

15. The transparency of claim 1, wherein said aircraft transparency is a transparency of an electric vertical takeoff and landing (eVTOL) aircraft.

16. A solar control product, comprising:
an acrylic material; and
a tungsten oxide additive dispersed in said acrylic material.

17. The product of claim 16, wherein said acrylic material is PMMA.

18. The product of claim 16, wherein said tungsten oxide component comprises cerium doped tungsten oxide.

19. The product of claim 16, wherein said tungsten oxide component comprises no more than 0.1% by weight of said solar control product.

20. The product of claim 16, wherein said tungsten oxide component comprises no more than 0.02-0.05% by weight of said solar control product.

21. The product of claim 16, wherein said solar control product has a first transmissivity for visible spectrum radiation of at least 60%, a second transmissivity for near infrared radiation of no more than 40%, and a third transmissivity for ultraviolet radiation of no more than 10%.

22. The transparency of claim 22, wherein said first transmissivity is at least 70%, said second transmissivity is no more than 30% and said third transmissivity is no more than 5%.

23.-41. (canceled)

42. A method for manufacturing an aircraft transparency, comprising:
providing a solar control product comprising an acrylic material and a tungsten oxide component;
processing said solar control product so that it is formed into the desired dimensions for said aircraft transparency.

43. The method of claim 42, wherein said processing comprises casting said solar control product in a mold to form said aircraft transparency.

44. The method of claim 42, wherein said processing comprises stretching said solar control sheet and then forming said stretched solar control sheet to form said aircraft transparency.

45. The method of claim 42, wherein said solar control product has a first transmissivity for visible spectrum radiation of at least 60%, a second transmissivity for near infrared radiation of no more than 40%, and a third transmissivity for ultraviolet radiation of no more than 10%.

46. (canceled)

47. The method of claim 42, wherein said tungsten oxide component comprises cerium doped tungsten oxide.

48.-49. (canceled)

50. The method of claim 42, wherein said tungsten oxide component comprises no more than 0.02-0.05% by weight of said solar control product.

51.-57. (canceled)
